(19) United States
(12) Patent Application Publication
(10) Pub. No.: US 2016/0040618 A1
(43) Pub. Date: Feb. 11, 2016

(54) CONTROL OF AN INTERNAL COMBUSTION ENGINE

(71) Applicant: TOYOTA JIDOSHA KABUSHIKI KAISHA, Toyota-shi (JP)

(72) Inventor: Masanao IDOGAWA, Toyota-shi (JP)

(21) Appl. No.: 14/780,947

(22) PCT Filed: Mar. 28, 2014
(86) PCT No.: PCT/IB2014/000430

§ 371 Date: Sep. 28, 2015

(30) Foreign Application Priority Data
Mar. 29, 2013 (JP) 2013-073548

(51) Int. Cl. F02D 41/40; F02D 41/14; F02D 41/30

(52) U.S. Cl. CPC F02D 41/401; F02D 41/3076; F02D 41/3005; F02D 41/1401

(57) ABSTRACT

An electronic control unit for an internal combustion engine configured to achieve demands concerning various kinds of functions of an internal combustion engine by coordinative control of a plurality of actuators concerning an operation of the internal combustion engine. The electronic control unit of the internal combustion engine is provided with a demand generation r level, a physical quantity mediation level, a controlled variable setting level, and a controlled variable mediation level. The controlled variable mediation level is provided just below the controlled variable setting level and includes a fundamental injection control mediation portion which mediates demand variables transmitted from the demand generation level not through the physical quantity mediation level and mediates controlled variables of the injections during a driving of the engine and a startup injection control mediation portion which mediates an, injection controlled variable upon startup.

### BACKGROUND OF THE INVENTION

1. Field of the Invention

The present invention relates to an electronic control unit for achieving demands concerning various kinds of functions of an internal combustion engine by coordinative control of a plurality of actuators and a control method thereof.

2. Description of Related Art

As disclosed in, for example, Japanese Patent Application Publication No. 2009-47101 (JP 2009-47101 A) and Japanese Patent Application Publication No. 2009-47102 (JP 2009-47102 A), there have been known electronic control units for the internal combustion engine including a hierarchical control structure in which a signal is transmitted in a single direction from a higher level to a lower level. In the examples described in the aforementioned respective literatures, a demand value is generated by expressing fundamental three functions in the internal combustion engine for a vehicle with three kinds of physical quantities on the highest demand generation level. The fundamental three functions of the internal combustion engine for a vehicle are drivability, exhaust gas and fuel consumption. The three kinds of physical quantities are torque, efficiency and air-fuel ratio.

A signal of a demand value generated on the highest demand generation level is transmitted to a lower physical quantity mediation level. On the physical quantity mediation level, the transmitted demand values are aggregated to each of torque, efficiency and air-fuel ratio and mediated to each demand value according to a predetermined rule. The demand value signal of each of the torque, efficiency and air-fuel ratio mediated in the above way is transmitted to a lower controlled variable setting level. On the controlled variable setting level, each demand value is adjusted based on a relationship between respective demand values and then, a controlled variable of each actuator is set up.

In this way, the demand for the internal combustion engine can be expressed with a combination of three kinds of physical quantities of torque, efficiency and air-fuel ratio, and mediated. By mediating the demand for the internal combustion engine as described above, an operation of the entire internal combustion engine which should be achieved by controlling the internal combustion engine is determined regardless of the characteristic and kind of an actuator, so that a preferable control which satisfies the fundamental demands about drivability, exhaust gas and fuel consumption of the internal combustion engine at an excellent balance can be achieved.

### SUMMARY OF THE INVENTION

A cylinder ignition type internal combustion engine in which fuel is injected directly into a cylinder of the internal combustion engine ensures a high freedom in injection control. Thus, there is a demand for changing injection timing or injection frequency appropriately to form an excellent fuel-air mixture in the internal combustion engine cylinder by making the best use of the freedom in injection control of the cylinder injection type internal combustion engine. The controlled variable which expresses a demand for changing injection timing or injection frequency is directly related to an operation of a fuel injection valve. Converting just the operation of the fuel injection valve to physical quantities such as torque, efficiency temporarily, mediating those values and recalculating the controlled variable is a waste arithmetic operation thereby generating an excess arithmetic operation load.

Usually, during a driving of the internal combustion engine, a real intake air amount is calculated according to a signal from a sensor and then, the amount of air to be charged into the cylinder is calculated using the calculated intake air amount so as to determine a fuel injection amount so that a predetermined target air-fuel ratio is achieved. Because the amount of air charged into the cylinder of the internal combustion engine cannot be calculated precisely upon startup of the internal combustion engine, a fuel injection amount upon startup of the internal combustion engine is set to an appropriate value. That is, calculation for injection control upon startup of the internal combustion engine is different from calculation for injection control during a driving of the internal combustion engine.

With respect to fuel injection control during the driving of the internal combustion engine as well as fuel injection control upon startup of the internal combustion engine which is different from during the driving of the internal combustion engine, there are various different kinds of demands depending on the state of the internal combustion engine. Therefore, the injection timing and injection frequency of the internal combustion engine or an injection amount of each injection of the internal combustion engine cannot be determined uniformly, and the injection timing and injection frequency of the internal combustion engine and a demand for an injection amount must be mediated.

In views of the above-described problems, an object of the present invention is to provide an electronic control unit with a hierarchical structure which satisfies fundamental demands for the internal combustion engine through physical quantity mediation at an excellent balance by mediating various kinds of demands concerning injection control without increasing arithmetic operation load for the control, in which a preferable injection control suitable for a state of the internal combustion engine including upon startup is achieve.

To achieve the above-described object, the present invention provides an electronic control unit which includes a controlled variable mediation level to which a demand value concerning fuel injection control is transmitted not through physical quantity mediation level, the controlled variable mediation level being configured that the demand values of the internal combustion engine, that is, the controlled variables of the injection are sorted to during a driving of the internal combustion engine and upon startup thereof and that the sorted demand values, that is, the controlled variables of the injection are mediated.

More specifically, a first aspect of the present invention provides an electronic control unit for an internal combustion engine, the electronic control unit being configured to achieve demands concerning various kinds of functions of the internal combustion engine by coordinative control of a plurality of actuators concerning an operation of the internal combustion engine. The electronic control unit includes a demand generation level, a physical quantity mediation level that is provided just below the demand generation level, a controlled variable setting level that is provided just below the physical quantity mediation level, and a controlled variable mediation level that is provided just below the controlled variable setting level. The demand generation level generates and outputs a request value concerning the function of the internal combustion engine. The physical quantity mediation level aggregates and mediates demand values expressed with predetermined physical quantities of the demand values. The controlled variable setting level sets controlled variables of the actuators based on the mediated demand values. The controlled variable mediation level is provided just below the controlled variable setting level. The demand values expressed with the controlled variables of the actuators of the demand values output from the demand generation level are transmitted to the controlled variable, mediation level not through the physical quantity mediation level. The controlled variable mediation level aggregates and mediates demand values expressed with controlled variables of the actuators set on the controlled variable setting level and the demand values expressed with the controlled variables of the actuators of the demand values which are transmitted to the controlled variable mediation level not through the physical quantity mediation level for each of the controlled variables. The electronic control unit includes a hierarchical control structure. In the hierarchical control structure, the demand values output from the demand generation level are transmitted in a single direction from a higher level to a lower level in order of the demand generation level, the physical quantity mediation level and the controlled variable setting level. The controlled variable mediation level includes a fundamental injection control mediation portion and a startup injection control mediation portion. The fundamental injection contra mediation portion mediates controlled variables of injections concerning an operation of at least one of fuel injection valves which is one of the actuators during a driving of the internal combustion engine. The startup injection control mediation portion mediates the controlled variables of the injections upon startup of the internal combustion engine.

In the electronic control unit of internal combustion engine configured in the above-described structure, a demands concerning various kinds of functions of the internal combustion engine are expressed with a predetermined physical quantities (e.g., torque, efficiency, air-fuel ratio) and mediated. A controlled variable of each actuator is set based on this mediated demand value. As a result, a plurality of actuators is controlled coordinatively so that fundamental function demands of the internal combustion engine (e.g., drivability, exhaust gas, fuel consumption) are satisfied at an excellent balance.

At that time, a demands concerning an operation of at least one of the fuel injection valves may be expressed with a predetermined controlled variables of the injections such as injection amount, injection timing, and injection frequency. The demand values expressed with the controlled variables of the injection are transmitted from the demand generation level to a lower controlled variable mediation level located not through the physical quantity mediation level and the controlled variable setting level. Then, the demand value expressed with a transmitted controlled variable of injection is mediated and reflected on a controlled variable for the actuators (throttle valve, igniter as well as fuel injection valve).

That is, the demand concerning the operation of the fuel injection valve is mediated as a controlled variable of the injection not through the physical quantity mediation and reflected on control of the internal combustion engine. That is, no waste arithmetic operation load such as converting the demand concerning the operation of the fuel injection valve to a physical quantity such as torque temporarily occurs. In addition, even if the demand about the injection control changes with a change of the specification of the fuel injection valve, for example, control processing of the physical quantity mediation level and the controlled variable setting level does not have to be changed. As a result, there is such a merit that portions which should be changed in the control program are a few thereby contributing to reduction in development man-hours.

In addition, according to the first aspect of the present invention, the controlled variable mediation level is provided with the fundamental injection control mediation portion which mediates the controlled variables of the injections during a driving of the internal combustion engine and the startup injection control mediation portion which mediates the controlled variables of the injections upon startup. Thus, the injection control demand which is dispatched depending on a state of the internal combustion engine during a driving of the internal combustion engine or upon startup thereof can be mediated preferably with each different logic. In addition, arithmetic operation load can be reduced compared with a configuration in which the two mediation portions are integrated.

As a demand (signal) which is transmitted from the demand generation level to the controlled variable mediation level not through the physical quantity mediation level as well as the controlled variable of the injection, demands with a priority under a specific condition can be mentioned. The demand with a priority under a specific condition refers to a demand with urgency such as fail safe, retardation control of ignition timing for quick warm-up of catalyst, for example. The demand value with a priority under a specific condition is not mediated by replacing with a physical quantity temporarily but expressed with a controlled variable of the actuator and transmitted directly to the controlled variable mediation level, thereby accelerating the processing.

If the fuel injection valve is a fuel injection valve which injects fuel directly into a cylinder of the internal combustion engine, a parameter related to fuel injection amount in the compression stroke of the cylinder by means of the fuel injection valve can be mentioned as the controlled variable of the injection. If the fuel injection amount in the compression stroke increases excessively, deflection in concentration of fuel-air mixture increases so that the combustion state may worsen. Thus, as an example, in the fundamental injection control mediation portion, the upper limit value of the fuel injection amount in the compression stroke may be mediated.

If the first fuel injection valve arranged to inject fuel directly into the cylinder of the internal combustion engine and the second fuel injection valve arranged to inject fuel into the intake port of each cylinder are provided, as the controlled variable of the injection, the fundamental injection control mediation portion may at least mediate a frequency of fuel injections to be performed by the first fuel injection valve and the second fuel injection valve and ratio in the fuel injection amount among respective injection times.

The reason is as follows. Fuel injected into the intake port is mixed with air preliminarily and sucked into the cylinder. On the other hand, fuel mist injected directly into the cylinder of the engine diffuses to form a fuel-air mixture with a high concentration. Thus, the frequency of fuel injections of the first and second fuel injection valves and the ratio in fuel injection amount thereby affect a distribution of fuel-air mixture formed within the cylinder and combustibility thereof largely.

Any structure in which a fuel injection valve is provided in each cylinder of the internal combustion engine may be adopted as long as it mediates the frequency of fuel injections and the ratio in fuel injection amount among respective injection times as an injection controlled variable. A configuration including the first and second fuel injection valves may be also adopted as described above. Further, regardless of the number of the fuel injection valves, the frequency of fuel injections in a single combustion cycle may be once or plural times. Thus, even if the specification of the fuel injection valve or the demand for the injection control changes, portions which should be changed in the control program are a few thereby contributing to reduction in the development man-hour.

Here, the demands expressed with the controlled variable of the injection may be distinguished between demand with a high priority and demand with a low priority preliminarily. After the controlled variable of the injection concerning the demand with a low priority is mediated, the fundamental injection control mediation portion may mediate the mediated injection controlled variable together with the controlled variable of the injection concerning the demand with a high priority.

Although a total fuel injection amount by the first fuel injection valve and the second fuel injection valve may be changed, from viewpoint of combustibility of fuel-air mixture, as an example, the demand value (injection controlled variable) concerning fuel injection control can be sorted to a demand in which the frequency of injections in each fuel injection valve (first kind of demand) and a demand in which both the total injection amount and the frequency of injections are changed (second kind of demand).

In this case, the second kind of demand affects combustibility of fuel-air mixture more largely than the first kind of demand. From viewpoint of influence on combustibility, it can be considered that the second kind of demand is a demand with a higher priority and the first kind of demand is a demand with a lower priority.

After the controlled variable of injection concerning the first kind of demand which affects combustibility less is mediated, the fundamental injection control mediation portion may mediate this controlled variable of the injection together with the controlled variable of the injection concerning the second kind of demand. As a result, the first kind of demand and the second kind of demand which affect combustibility of fuel-air mixture differently can be distinguished so that they can be mediated preferably with a different logic.

In some case, such a plurality of the demands may be distinguished and mediated in each different way and in some case, the plurality of the demands may be mediated integrally. That is, the distribution and combustibility of fuel-air mixture formed in the combustion chamber of the cylinder affect not only the fuel injection amount of the first and second fuel injection valves and the frequency of fuel injections (injection controlled variables) but also the injection pressure of fuel largely, as described above. Thus, when mediating the controlled variables of the injection, by correlating with the fuel injection pressure, it is preferable to mediate the pump controlled variable concerning the operation of the fuel pump as well as the fuel injection controlled variable.

During a stop of the internal combustion engine, it is desirable to stop not only the fuel injection by the fuel injection valve but also the fuel pump. As an example, the controlled variable mediation level may be provided with the control mediation portion which mediates the pump controlled variable concerning the operation of the fuel pump by correlating with mediating the controlled variable of the injection in the fundamental injection control mediation portion and the startup injection control mediation portion.

More specifically, when mediating the controlled variable of the injection to stop the operation of the fuel injection valve by means of the fundamental injection control mediation portion, the pump control mediation portion may mediate the pump discharge amount which is a pump controlled variable to stop the operation of the fuel pump by correlating with stopping the operation of the fuel injection valve. As a result, when automatically stopping the operation of the internal combustion engine with a stop of a vehicle, for example, the operation of the fuel pump can be stopped at the same time when the fuel injection is stopped. Consequently, driving loss of the pump can be reduced thereby improving fuel consumption performance.

In this case, it is permissible to provide a discharge amount limiting portion which sets a lower limit value of the pump discharge amount mediated by the pump control mediation portion. As a result, even if the pump controlled variable is mediated to stop the operation of the fuel pump as described above when stopping the fuel injection, the fuel pump can be started as required. For example, when preparing for a next startup control during a stop of the internal combustion engine, the fuel pump has to be started.

Further, if the fuel injection valve is arranged to inject fuel directly into the cylinder of the internal combustion engine and the fuel pump is a high-pressure pump capable of supplying fuel with a higher pressure than a predetermined level to the fuel injection valve, when mediating the controlled variable of the injection to activate the fuel injection valve in the compression stroke of the cylinder of the internal combustion engine by means of the fundamental injection control mediation portion, the pump control mediation portion may mediate a target pump fuel pressure which is the pump controlled variable to raise fuel injection pressure by the operation of the high-pressure pump by correlating with mediation of the controlled variable of the injection to activate the fuel injection valve.

As a result, when fuel is injected in the compression stroke in which the pressure in the cylinder of the internal combustion engine is raised, the fuel injection pressure can be increased by means of the high-pressure pump to achieve formation of excellent fuel-air mixture. On the other hand, if no fuel is injected in the compression stroke, the fuel injection pressure is reduced relatively thereby reducing driving loss of the pump.

In this case, it is permissible to provide a target fuel pressure limiting portion which sets at least one of the upper limit value and the lower limit value of the target pump fuel pressure mediated by the pump control mediation portion. As a result, even if the pump controlled variable is mediated to activate the high-pressure pump as described above by correlating with the fuel injection in the compression stroke, the fuel pressure can be reduced to protect the fuel injection valve, for example. To the contrary, even if the pump controlled variable is mediated to stop the high-pressure pump by correlating with the injection control, only the high-pressure pump can be activated as required.

According to the present invention, by expressing the fundamental function demands of the internal combustion engine with physical quantities about drivability, exhaust gas and fuel consumption and mediating the demands on the physical quantity mediation level, a preferable control in which the fundamental demands of the internal combustion engine are satisfied at an excellent balance can be achieved. Further, by mediating the demands concerning the fuel injection valves as the controlled variable or the injection not through the physical quantity mediation, the mediated demands can be reflected on control of the internal combustion engine preferably without increasing the arithmetic operation load excessively.

Still further, separately from the fundamental injection control mediation portion which mediates the controlled variables of the injection during an operation of the internal combustion engine, the startup injection control mediation portion which mediates the controlled variable of the injection upon startup of the engine is provided. Thus, injection control demands which differ between during a driving and upon startup of the internal combustion engine due to a different logic can be mediated preferably. Further, by separating the mediation portion depending on during a driving of the internal combustion engine and upon startup thereof, both the mediation portions can reduce the arithmetic operation load therefor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram showing an example of an internal combustion engine according to an embodiment of the present invention;

FIG. 2 is a configuration diagram showing an example of an electronic control unit (ECU) according to the embodiment;

FIG. 3 is a block diagram showing a hierarchical structure of an electronic control unit according to the embodiment;

FIG. 4 is a block diagram showing mediation of an injection controlled variable in an injection function mediation portion;

FIG. 5 is a block diagram showing an example of the configuration of an injector driving control portion; and

FIG. 6 is a diagram equivalent to FIG. 4 concerning mediation of a pump controlled variable in the injection function mediation portion.

### DETAILED DESCRIPTION OF EMBODIMENTS

Hereinafter, embodiments of the present invention will be described with reference to the accompanying drawings. The embodiments will be described about cases in which the electronic control unit of the present invention has been applied to an internal combustion engine (hereinafter referred to as engine) loaded on a vehicle, particularly to cases in which it is applied to a spark ignition type engine.

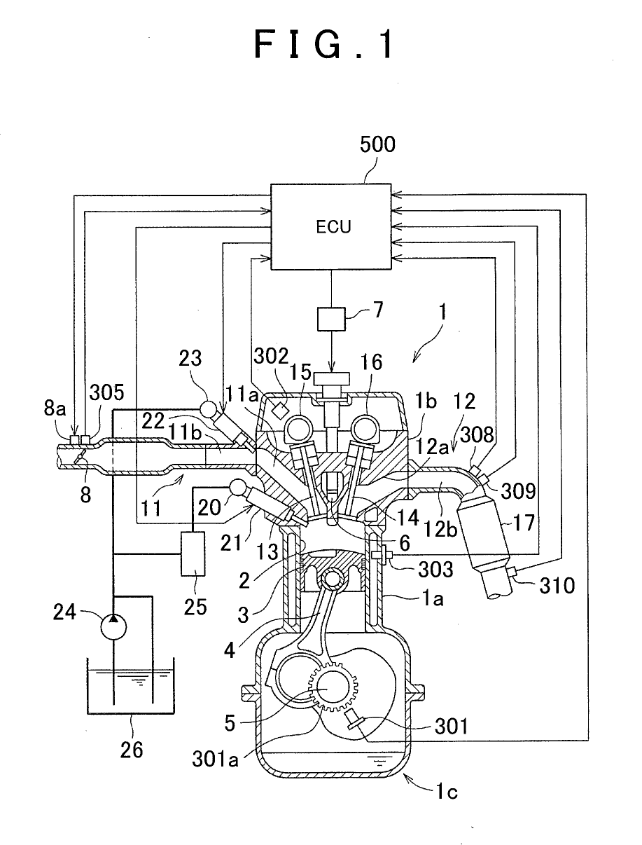

Hereinafter, referring to FIG. 1, an example of the structure of the spark ignition type engine 1 according to an embodiment will be described. Although FIG. 1 illustrates only a structure of a cylinder 2 in the main body of the engine 1, the engine 1 is an in-line four-cylinder engine, for example. A piston 3 is accommodated in the cylinder 2 formed in a cylinder block 1a such that it reciprocates in a vertical direction in FIG. 1. A cylinder head 1b is mounted on the top of the cylinder block 1a. A combustion chamber is produced between a bottom surface of the cylinder head 1b and the top surface of the piston 3.

A piston 3 is connected to a crank shaft 5 via a connecting rod 4. The crank shaft 5 is accommodated in a crank case of a bottom portion of the cylinder block 1a. A rotor 301a is attached to the crank shaft 5. A crank position sensor 301 is disposed near the side of the rotor 301a. The crank position sensor 301 is an electromagnetic pickup, for example. When threads on the outer periphery of the rotor 301a pass, the crank position sensor 301 outputs a pulse signal. The engine speed is calculated from this signal.

Further, a water jacket is formed to surround the cylinder 2 on the side wall of the cylinder block 1a. A water temperature sensor 303 is disposed in the water jacket to detect a temperature of engine cooling water w. The bottom portion of the cylinder block 1a is expanded downward of the engine to form an upper half of the crank case. An oil pan 1c is attached to the bottom of the cylinder block 1a to form a lower half of the crank case. Lubricant (engine oil) to be supplied to each part of the engine is stored in the oil pan 1c.

On the other hand, an ignition plug 6 is disposed on the cylinder head 1b such that it faces the combustion chamber in the cylinder 2 of the engine 1. The ignition plug 6 is supplied with a high voltage power from an igniter 7. A timing for supplying high voltage power to the ignition plug 6, namely, an ignition timing of the engine 1 is adjusted by the igniter 7. That is, the igniter 7 is an actuator which is capable of adjusting the ignition timing of the engine 1 and controlled by an electronic control unit (ECU) 500 described below.

An intake air port 11a and an exhaust air port 12a are formed in the cylinder head 1b such that they are open to the combustion chamber in the cylinder 2 of the engine 1. An intake manifold 11b communicates with the intake air port 11a, so that the intake manifold 11b forms a downstream side of intake air flow through an intake air passage 11. An exhaust air manifold 12b communicates with an exhaust air port 12a, so that the exhaust air manifold 12b forms an upstream side of exhaust gas flow through an exhaust air passage 12.

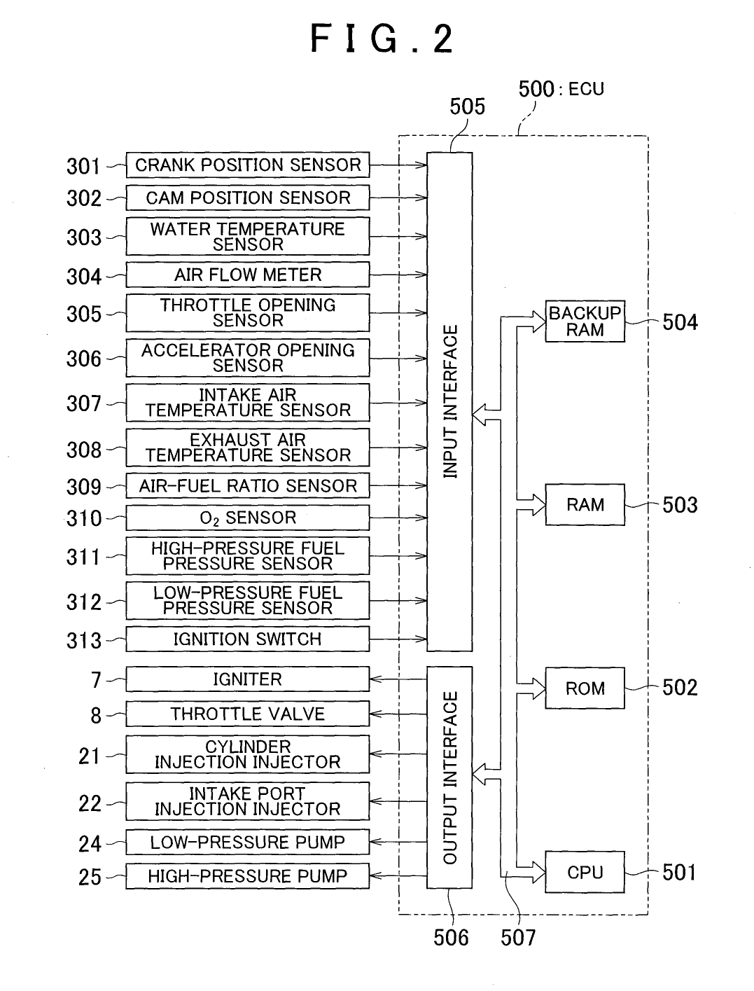

An air flow meter 304 (see FIG. 2) for detecting an amount of intake air is disposed near an air cleaner (not shown) on the upstream side of the intake air passage 11. A throttle valve 8 for adjusting the amount of intake air is disposed on the downstream side, thereof. An intake air temperature sensor 307 (see FIG. 2) for detecting the temperature of air (intake air temperature) before sucked by the engine 1 is also disposed in the intake air passage 11 (intake air manifold 11b).

In this example, the throttle valve 8 is disconnected mechanically from an accelerator pedal (not shown) and driven by an electric throttle motor 8a. The opening amount of the throttle valve 8 is adjusted by the electric throttle motor 8a. A signal from the throttle opening sensor 305 which detects an opening amount of the throttle valve 8 is transmitted to the ECU 500 described below. The ECU 500 controls the throttle motor 8a to obtain a preferable amount of intake air depending on the operating state of the engine 1. That is, the throttle valve 8 is an actuator which adjusts the amount of intake air of the engine 1 (concerning an operation of the internal combustion engine).

The opening of the intake air port 11a which faces the combustion chamber is opened/closed by the intake valve 13. That is, the intake air passage 11 and the combustion chamber are connected or disconnected by the intake valve 13. Likewise, the opening of the exhaust air port 12a is opened/closed by the exhaust air valve 14. That is, the exhaust air passage 12 and the combustion chamber are connected or disconnected by the exhaust valve 14. The opening/closing drive of the intake valve 13 and the exhaust valve 14 is carried out by an intake camshaft 15 and an exhaust camshaft 16 respectively. A rotation of the crank shaft is transmitted to the intake camshaft 15 and the exhaust camshaft 16 via a timing chain or the like.

In this example, a cam position sensor 302 is provided near the intake camshaft 15. When the piston 3 of a specific cylinder 2 reaches its compression top dead center, the cam position sensor 302 generates a pulse signal. The cam position sensor 302 is constituted of an electromagnetic pickup, for example. Like the aforementioned crank position sensor 301, the cam position sensor 302 outputs a pulse signal with a rotation of a rotor provided on the intake air camshaft 15.

As an example, a catalyst 17 composed of three-way catalyst is disposed in the downstream of the exhaust air manifold 12b in the exhaust air passage 12. This catalyst 17 oxidizes CO, HC in exhaust gas which is discharged from the combustion chamber in the cylinder 2 into the exhaust air passage 12 and reduces NOx to produce harmless CO₂, H₂O, N₂ thereby purifying exhaust gas.

In this example, an exhaust air temperature sensor 308 and an air-fuel (A/F) ratio sensor 309 are disposed in the exhaust air passage 12 on the upstream side of the catalyst 17. An O₂ sensor 310 is disposed in the exhaust air passage 12 on the downstream side of the catalyst 17.

Next, a fuel injection system of the engine 1 will be described.

A cylinder injection injector 21 (first fuel injection valve) which injects fuel directly into each combustion chamber is disposed in each cylinder 2 of the engine 1. The cylinder injection injector 21 of each of four cylinders 2 is connected to a common high-pressure fuel delivery pipe 20. An intake port injection injector 22 (second fuel injection valve) which injects fuel into each intake air port 11a is disposed in the intake air passage 11 of the engine 1. The intake port injection injector 22 is also provided on each of the four cylinders 2 and connected to a common low-pressure fuel delivery pipe 23.

A low-pressure pump 24 which is a fuel pump supplies fuel to the low-pressure fuel delivery pipe 23. A high-pressure pump 25 which is a fuel pump supplies fuel to the high-pressure fuel delivery pipe 20. Hereinafter, the low-pressure pump is also referred to as a fuel pump 24 and the high-pressure, pump is also referred to as a fuel pump 25. Fuel in a fuel tank 26 is pumped by the low-pressure pump 24 and that fuel is supplied to the low-pressure fuel delivery pipe 23 and the high-pressure pump 25. Low-pressure fuel is pressurized up to a higher pressure than a predetermined level by the high-pressure pump 25 and the pressurized fuel is supplied to the high-pressure fuel delivery pipe 20.

A high-pressure fuel pressure sensor 311 (see FIG. 2) for detecting a pressure (fuel pressure) of high-pressure fuel supplied to the cylinder injection injector 21 is disposed in the high-pressure fuel delivery pipe 20. A low-pressure fuel pressure sensor 312 (see FIG. 2) for detecting a pressure (fuel pressure) of low-pressure fuel supplied, to the intake port injection injector 22 is disposed in the low-pressure fuel delivery pipe 23.

Both the cylinder injection injector 21 and the intake port injection injector 22 are electromagnetically-driven actuators. When a predetermined voltage is applied, this electromagnetically-driven actuator is opened to inject fuel. The high-pressure pump 25 and the low-pressure pump 24 are actuators for supplying fuel to the injectors 21, 22. The operations of the injectors 21, 22 are controlled by the ECU 500 described below. The operations of the injectors 21, 22 include a fuel injection frequency (injection mode), a timing for injection start in each fuel injection session, an injection amount of each fuel injection session, a discharge mount of each of the fuel pumps 24, 25, a discharge pressure (target fuel pressure) of each of the fuel pumps 24, 25.

Then, fuel is injected from any one or both of the cylinder injection injector 21 and the intake port injection, injector 22 so that fuel-air mixture of air and fuel gas is formed within the combustion chamber of the cylinder 2. The formed fuel-air mixture is ignited by the ignition plug 6 so that it burns and explodes. The piston 3 is pressed down by high-temperature, high-pressure combustion gas produced at this time to rotate the crank shaft 5. With opening of the exhaust air valve 14, the combustion gas is discharged into the exhaust air passage 12 as exhaust gas.

As shown schematically in FIG. 2, the ECU 500 includes a central processing unit (CPU) 501, a read-only memory (ROM) 502, a random access memory (RAM) 503 and a backup RAM 504.

Various kinds of control programs and maps to be referred in executing those various kinds of control programs are stored in the ROM 502. The CPU 501 executes various kinds of arithmetic processing based on the various kinds of control programs and maps stored in the ROM 502. The RAM 503 is a memory which stores an arithmetic result in the CPU 501 and data input from each sensor temporarily. The backup RAM 504 is a nonvolatile memory which stores data which should be stored when the engine 1 is stopped, for example.

The CPU 501, the ROM 502, the RAM 503 and the backup RAM 504 are connected to each other via a bus 507 and are connected to an input interface 505 and an output interface 506.

Various sensors are connected to the input interface 505. The various sensors include a crank position sensor 301, a cam position sensor 302, a water temperature sensor 303, an air flow meter 304, a throttle opening sensor 305, an accelerator opening sensor 306, an intake air temperature sensor 307, an exhaust air temperature sensor 308, an air-fuel ratio sensor 309, an O₂ sensor 310, a high-pressure fuel pressure sensor 311 and a low-pressure fuel pressure sensor 312.

An ignition switch 313 is connected to the input interface 505. When this ignition switch 313 is turned ON, cranking of the engine 1 by a starter motor (not shown) is started. On the other hand, the igniter 7 of the ignition plug 6, the throttle motor 8a of the throttle valve 8, the cylinder injection injector 21, the intake port injection injector 22, the low-pressure pump 24, and the high-pressure pump 25 are connected to the output interface 506.

Then, the ECU 500 executes various controls of the engine 1 based on signals from the aforementioned various sensors 301 to 312 and the switch 313. The various controls of the engine 1 include energization control of the ignition plug 6 by the igniter 7, drive control of the throttle valve 8 (throttle motor 8a), and drive control of the injectors 21, 22 and the pumps 24, 25.

As a result, the operating state of the engine 1 is preferably controlled so that demands about fundamental functions including drivability, exhaust gas and fuel consumption are satisfied at an excellent balance. That is, the ECU 500 achieves demands about various functions of the engine 1 by coordinative control of plural actuators (igniter 7, throttle valve 8, injectors 21, 22, pumps 24, 25). An electronic control unit for the internal combustion engine according to an embodiment of the present invention is achieved by the control program which is to be executed by the ECU 500.

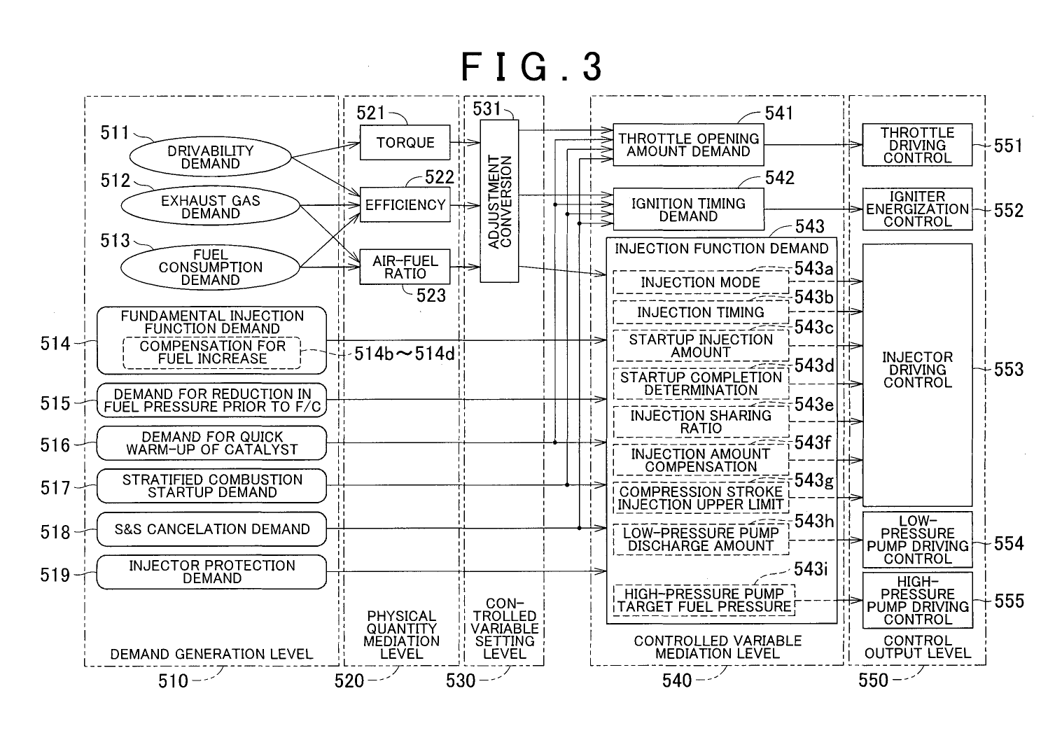

Next, the configuration of the electronic control unit will be described in detail. FIG. 3 shows respective elements of the electronic control unit with blocks and transmission of a signal between the blocks is indicated with an arrow. In this example, the electronic control unit has a hierarchical control structure composed of five levels 510 to 550. The demand generation level 510 is provided on the highest level of the five ones. A physical quantity mediation level 520 and a controlled variable setting level 530 are provided below the demand generation level 510. A controlled variable mediation level 540 is provided below the controlled variable setting level 530 and a control output level 550 is provided on the lowest level of the five ones.

Signal flow is in a single direction between the aforementioned five levels 510 to 550. A signal is transmitted from the demand generation level 510 to the lower physical quantity mediation level 520, from the physical quantity mediation level 520 to the controlled variable setting level 530, and further from the controlled variable setting level 530 to the controlled variable mediation level 540. In addition, a common signal distribution system is provided independently of the five levels 510 to 550 in which the signal flow is in a single direction. Common signals are distributed in parallel to each of the levels 510 to 550 by the common signal distribution system. Representation of the common signal distribution system is omitted here.

There is a following difference between a signal transmitted between the levels 510 to 550 and a signal distributed through the common signal distribution system. The signal transmitted between the five levels 510 to 550 is a signal of a demand about the function of the engine 1 which is finally converted to a controlled variable for the actuators 7, 8, [symbol] . To the contrary, the signal distributed by the common signal distribution system is a signal which contains information necessary for generating a demand or calculating a controlled variable.

More specifically, the signals distributed through the common signal distribution system include information concerning the operating condition and the operating state of the engine 1 (engine speed, intake air amount, estimated torque, real ignition timing at this time, cooling water temperature, operating mode). The information source thereof is from various sensors 301 to 312 provided in the engine 1 and estimation function inside the electronic control unit. If information concerning the operating condition and the operating state of the engine 1 is distributed in parallel to the respective levels 510 to 550, not only communication amount between the levels 510 to 550 can be reduced, but also simultaneity of information between the levels 510 to 550 can be held. The reason is that information concerning the operating condition and the operating state of the engine 1 is common engine information used commonly by the respective levels 510 to 550.

Hereinafter, the configuration of the respective levels 510 to 550 and processing executed there will be described in order from the highest level. A plurality of demand output portions 511 to 519 are disposed on the demand generation level 510. The demand output portions 511 to 519 are provided for each function of the engine 1. The demand mentioned here refers to a demand concerning the function of the engine 1 (or a performance required in the engine 1). Because the function of the engine 1 diversifies, a content of the demand output portion disposed on the demand generation level 510 differs depending on what is demanded to the engine 1 or to what is given priority to.

In the present embodiment, the control must be performed on the premise of satisfying drivability, exhaust gas and fuel consumption at an excellent balance in order to drive the engine 1 of a vehicle efficiently corresponding to a driver's driving operation and meet a demand for natural environment protection. Drivability, exhaust gas and fuel consumption are fundamental functions of the engine 1. Thus, the demand output portion 511 corresponding to the function concerning drivability, the demand output portion 512 corresponding to the function concerning exhaust gas, and the demand output portion 513 corresponding to the function concerning fuel consumption are provided on the demand generation level 510.

According to the present embodiment, it is considered that respective demands exist which occur depending any specific condition as well as the demands concerning the aforementioned three fundamental functions. The respective demands which occur depending on any specific condition include fundamental demands for injection function, for example, timing and frequency of injection operation of each of the injectors 21, 22, reduction in fuel pressure prior to fuel cut (F/C), quick warm-up of catalyst 17, startup in stratified combustion state, and cancelation of start and stop (S&S) which is no idling. As shown in FIG. 3, the demand output portions 514 to 519 corresponding to each of the aforementioned demands are provided on the demand generation level 510. These demand outputs portions 514 to 519 will be described in detail.

The demand output portions 511 to 513 digitize and outputs drivability, exhaust gas and fuel consumption which are demands concerning the fundamental functions of the engine 1. By digitizing a demand concerning the function of the engine 1, the demand concerning the function of the engine 1 can be reflected on the controlled variables of the actuators 7, 8, [symbol] . The arithmetic operation for determining the controlled variables of the actuators 7, 8, [symbol] will be described below. In the present embodiment, the demand concerning the fundamental function of the engine 1 is expressed with a physical quantity concerning an operation of the engine 1.

As the physical quantity concerning the operation of the engine 1, only three physical quantities, i.e., torque, efficiency and air-fuel ratio are used. The output of the engine 1 is mainly torque, heat and exhaust gas (heat and ingredient). The output of the engine 1 is related to the aforementioned fundamental functions of the engine 1 such as drivability, exhaust gas, and fuel consumption. Thus, the three physical quantities of torque, efficiency and air-fuel ratio must be determined to control the output of the engine 1. That is, a demand concerning the fundamental function of the engine 1 can be reflected on the output of the engine 1 by expressing the demand concerning the fundamental functions of the engine 1 with three physical quantities and controlling the operations of the actuators 7, 8, [symbol] .

In FIG. 3, as an example, the demand output portion 511 outputs a demand concerning drivability (drivability demand). The demand concerning drivability is output as a demand value expressed with torque or efficiency. For example, if the demand is about acceleration of a vehicle, that demand can be expressed with torque. If the demand is about prevention of engine stall, that demand can be expressed with efficiency (raising efficiency).

The demand output portion 512 outputs a demand concerning exhaust gas. The demand concerning exhaust gas is output as a demand value expressed with efficiency or air-fuel ratio. For example, if the demand is about warm-up of the catalyst 17, that demand can be expressed with efficiency (decreasing efficiency) and it may be expressed with air-fuel ratio also. Decreasing efficiency raises exhaust gas temperature and air-fuel ratio can form an environment in which the catalyst 17 reacts easily.

In addition, the demand output portion 513 outputs a demand concerning fuel consumption. The demand concerning fuel consumption is output as a demand value expressed with, efficiency or air-fuel ratio. For example, if the demand is increasing combustion efficiency, that demand may be expressed with efficiency (increasing efficiency). If the demand is decreasing pumping loss, that demand may be expressed with air-fuel ratio (lean burn).

In the meantime, the demand values output from the demand output portions 511 to 513 are not limited to one demand about each physical quantity. As an example, the demand output portion 511 outputs not only a torque which a driver demands (torque calculated from an opening amount of accelerator) but also a torque which various devices related to vehicle control demand at the same time. The various devices related to vehicle control are vehicle stability control system (VSC), traction control system (TRC), antilock brake system (ABS), and transmission. The same thing can be said of efficiency.

Common engine information is distributed from the common signal distribution system to the demand generation level 510. By referring to the distributed common engine information, the respective demand output portions 511 to 513 determine a demand value which should be output. The reason is that the content of the demand changes depending on the operating condition or operating state of the engine 1. For example if catalyst temperature is measured by the exhaust air temperature sensor 308, the demand output portion 512 determines a necessity of warm-up of the catalyst 17 based on the temperature information. Then, corresponding to a result of the aforementioned determination, the demand output portion 512 outputs a demand value which is expressed with efficiency or air-fuel ratio.

As described above, the demand output portions 511 to 513 on the demand generation level 510 output a plurality of demands which are expressed with torque, efficiency or air-fuel ratio. However, it is impossible to achieve all the plural demands completely at the same time. The reason is that even if plural torques are demanded, only one torque can be achieved. Likewise, even if plural efficiencies are demanded, only one efficiency can be achieved and even if plural air-fuel ratios are demanded, only one air-fuel ratio can be achieved. Thus, processing for mediating such demands is necessary.

The physical quantity mediation level 520 mediates a demand value output from the demand generation level 510. The mediation portions 521 to 523 are provided on the physical quantity mediation level 520 for each physical quantity which corresponds to classification of the demands. The mediation portion 521 aggregates demand values expressed with torque and mediates to a torque demand value. The mediation portion 522 aggregates demand values expressed with efficiency and mediates to an efficiency demand value. Then, the mediation portion 523 aggregates demand values expressed with air-fuel ratio and mediates to an air-fuel ratio demand value.

These mediation portions 521 to 523 perform mediation according to a predetermined rule. The rule mentioned here refers to a calculation rule for obtaining a numerical value from plural numerical values, for example, selection of a maximum value, selection of a minimum value, an average or superposition and those plural calculation rules may be combined appropriately. However, which rule should be adopted depends on a design of the electronic control unit and the present invention does not restrict the content of the rule.

Additionally, the common engine information is distributed from the common signal distribution system to the physical quantity mediation level 520, so that the common engine information can be used by the respective mediation portions 521 to 523. For example, although the mediation rule may be changed depending on the operating condition or the operating state of the engine 1, as described below, the mediation rule is never changed considering a torque range which the engine 1 can achieve.

In the mediation portions 521 to 523, no upper limit torque or lower limit torque, which the engine 1 can achieve is considered in the mediation. Further, a result of mediation performed by one of the mediation portions 521 to 523 is not considered in the mediation of other mediation portions. That is, the respective mediation portions 521 to 523 perform mediation independently without considering the upper limit torque or lower limit torque of the torque range which the engine 1 can achieve or a mediation result by other mediation portions. This also contributes to reduction of arithmetic operation load for the control.

When the respective mediation portions 521 to 523 perform mediation as described above, a torque demand value, an efficiency demand value and an air-fuel ratio demand value are output from the physical quantity mediation level 520. Then, on the controlled variable setting level 530 which is a level just below the physical quantity mediation level 520, controlled variables for the actuators 7, 8, [symbol] are set based on the torque demand value, the efficiency demand value and the air-fuel ratio demand value mediated by the physical quantity mediation level 520.

According to the present invention, an adjustment converting portion 531 is provided on each one of the controlled variable setting level 530. The adjustment converting portion 531 adjusts a magnitude of a torque demand value, an efficiency demand value and an air-fuel ratio demand value mediated by the physical quantity mediation level 520. Because the torque range which the engine 1 can achieve is not considered in the mediation on the physical quantity mediation level 520 as described above, there is a possibility that the engine 1 may not be driven properly depending on the magnitude of each demand value. Then, the adjustment converting portion 531 adjusts each demand value based on a relationship between the respective demand values in order to enable the engine 1 to be driven properly.

The torque demand value, the efficiency demand value and the air-fuel ratio demand value are calculated independently on higher levels than the controlled variable setting level 530, so that calculated values are never used mutually or referred to each other between factors related to the calculation. That is, the torque demand value, the efficiency demand value and the air-fuel ratio demand value are referred to each other for the first time on the controlled variable setting level 530. Because the adjustment targets are limited to three, i.e., the torque demand value, the efficiency demand value, and the air-fuel ratio demand value, the arithmetic operation load required for the adjustment may be small.

How the aforementioned adjustment should be performed depends on the design of the electronic control unit and the content of the adjustment is not limited in the present invention. However, if there is an order of priority among the torque demand value, the efficiency demand value and the air-fuel ratio demand value, it is preferable to adjust (correct) a demand value with a lower priority. For example, in case of a demand value with a high priority, that demand value is reflected on the controlled variables of the actuators 7, 8, [symbol] as it is as much as possible. In case of a demand value with a low priority, that demand value is adjusted and the adjusted demand value is reflected on the controlled variables of the actuators 7, 8, [symbol] .

As a result, within a range in which the engine 1 is driven appropriately, a demand with a high priority can be achieved sufficiently while a demand with a low priority can be achieved to some extent. As an example, if the priority of the torque demand value is the highest, the efficiency demand value and the air-fuel ratio demand value are corrected. When the efficiency demand value and the air-fuel ratio demand value are corrected, of the efficiency demand value and the air-fuel ratio demand value, the degree of correction of a demand with a lower priority is made larger. If the order of the priority changes depending on the operating condition of the engine 1 or the like, the order of the priority is determined based on the common engine information distributed from the common signal distribution system and then, which demand value should be corrected is determined.

On the controlled variable setting level 530, a new signal is generated using a demand value input from the physical quantity mediation level 520 and the common engine information distributed from the common signal distribution system. For example, a ratio between the torque demand value mediated by the mediation portion 521 and an estimation torque contained in the common engine information is calculated by a division portion (not shown). The estimation torque is a torque which is output when the ignition timing is set to MBT with a current intake air amount and a current air-fuel ratio. The arithmetic operation for the estimation torque is performed in a different task of the electronic control unit.

If the priority of the torque demand value is the highest as described above although a detailed description is omitted, the torque demand value, a corrected, efficiency demand value, a corrected air-fuel ratio demand value and a torque efficiency are calculated by the controlled variable setting level 530. Of the torque demand value, the corrected efficiency demand value, the corrected air-fuel demand ratio value and the torque efficiency, a throttle opening amount is calculated (converted) from the torque demand value and the corrected efficiency demand value, and the calculated throttle opening amount is transmitted to the controlled variable mediation level 540.

More specifically, first, the torque demand value is divided by the corrected efficiency demand value. Because the corrected efficiency demand value is 1 or less, dividing the torque demand value by the corrected efficiency demand value raises the torque demand value. The raised torque demand value is converted to an amount of air and a throttle opening amount is calculated from the amount of air. In the meantime, conversion from the torque demand value to the amount of air and calculation of the throttle opening amount from the amount of air are carried out by reference to a predetermined map.

Further, the ignition timing is calculated (converted) from mainly torque efficiency. When the ignition timing is calculated, the torque demand value and the corrected air-fuel ratio demand value are used as a reference signal. More specifically, by reference to the map, a retard amount of the ignition timing relative to MBT is calculated from the torque efficiency. The smaller the torque efficiency, the larger the retard amount of the ignition timing is. As a result, the torque drops. The aforementioned raising of the torque demand value is processing for compensating for a reduction in the torque due to the retard of the ignition timing.

According to the present invention, both the torque demand value and the efficiency demand value can be achieved by the retard of the ignition timing based on the torque efficiency and the raising of the torque demand value based on the efficiency demand value. In the meantime, the torque demand value and the corrected air-fuel ratio demand value are used to select a map for converting the torque efficiency to the retard amount of the ignition timing. Then, a final ignition timing is calculated from the retard amount of the ignition timing and the MBT (or basic ignition timing).

As a result of the above processing, the signals transmitted from the controlled variable setting level 530 (adjustment converting portion 531) to the controlled variable mediation level 540 are a demand value of the throttle opening amount (a first demand value corresponding to the torque demand), a demand value of the ignition timing and a demand value of the air-fuel ratio. These signals are input to mediation portions 541, 542, 543 of the controlled variable mediation level 540 and then mediated with other demand values transmitted directly from the demand generation level 510 as described in detail below. A detailed description of the controlled variable mediation level 540 and the mediation portions 541 to 543 will be described later.

As shown in FIG. 3 for example, the controlled variable mediation level 540 includes the mediation portions 541 to 543 (543a to 543i) for each controlled variable of the actuators 7, 8, [symbol] based on the classification of the demands. In the example of FIG. 3, the mediation portion 541 aggregates the demand values of the throttle opening amount and mediates the aggregated throttle opening amount demand values to a single demand value. The mediation portion 542 aggregates the demand values of the ignition timing and mediates the aggregated ignition timing demand values to a single demand value.

Further, the mediation portion 543 mediates a plurality of controlled variable demand values concerning fuel injection collectively. In the example of FIG. 3, the mediation portion 543 is an injection function mediation portion in which first to seventh mediation portions 543a to 543g, an eighth mediation portion 543h, and a ninth mediation portion 543i are integrated. The first to seventh mediation portions 543a to 543g mediate seven injection controlled variables which indicate operations of the injectors 21, 22. The eighth mediation portion 543h mediates a discharge amount (pump controlled variable) of the low-pressure pump 24. The ninth mediation portion 543i mediates a discharge pressure of the high-pressure pump 25, that is, a target fuel pressure (pump controlled variable).

The injection function mediation portion 543 mediates the controlled variables of the plural actuators including the injectors 21, 22, the low-pressure pump 24, and the high-pressure pump 25 integrally by correlating to each other. Thus, the injection function mediation portion 543 is configured to achieve the functions of the nine mediation portions 543a to 543i, for example, in the same processing step of the control program. As a result, simultaneity of mediation of the controlled variables of the injectors 21, 22 and fuel pumps 24, 25 can be secured.

The respective mediation portions 541 to 543 (543a to 543i) perform mediation according to a predetermined rule like the respective mediation portions 521 to 523 on the physical quantity mediation level 520. The rule depends on the design of the electronic control unit and the present invention does not limit the content of the rule. In the meantime, the common engine information is distributed to the controlled variable mediation level 540 also from the common signal distribution system, so that the respective mediation portions 541 to 543 can use the common engine information.

As described above, the respective mediation portions 541 to 543 (543a to 543i) mediate various demands and as a result, signals about the demand values of the controlled variables of the respective actuators 7, 8, [symbol] are output from the controlled variable mediation level 540. The demand values of the controlled variables, of the respective actuators 7, 8, [symbol] output from the controlled variable mediation level 540 include a throttle opening amount demand value, an ignition timing demand value, demand values of the seven injection controlled variables described below concerning operations of the injectors 21, 22, a demand value of a discharge amount (pump controlled variable) of the low-pressure pump 24, and a demand value of a high-pressure pump target fuel pressure (pump controlled variable). The mediation to be performed on the respective mediation portions 541 to 543 (543a to 543i) will be described below.

Controlled variables of the actuators 7, 8, [symbol] are calculated based on each demand value on the control output level 550 which is a level below the controlled variable mediation level 540. In the example of FIG. 3, the lowest control output level 550 includes control output portions 551 to 555 corresponding to a signal transmitted from the aforementioned controlled variable mediation level 540. A throttle opening amount demand value is transmitted to the control output portion 551 (throttle drive control portion) from the mediation portion 541 of the demand value concerning the throttle opening amount and a throttle driving signal is output corresponding to the transmitted throttle opening amount demand value.

An ignition timing demand value is transmitted to the control output portion 552 (igniter energization control portion) from the mediation portion 542 of the demand value concerning the ignition timing of the aforementioned controlled variable mediation level 540 and an igniter energization signal is output corresponding to the transmitted ignition timing demand value. A demand value of an injection controlled variable is transmitted to the control output portion 553 (injector driving control portion) from the first to seventh mediation portions 543a to 543g of the injection function mediation portion 543 and an injector driving signal is output corresponding to the transmitted injection controlled variable.

A demand value of a fuel discharge amount is transmitted to the control output portion 554 (low-pressure pump driving control portion) from the eighth mediation portion 543h of the injection function mediation portion 543, and low-pressure pump driving signal is output corresponding to a demand value of the transmitted fuel discharge amount. A fuel pressure demand value is transmitted to the control output portion 555 (high-pressure pump driving control portion) from the ninth mediation portion 543i of the injection function mediation portion 543, and a high-pressure driving signal is output corresponding to the transmitted fuel pressure demand value.

Hereinafter, mediation of the controlled variable or the actuator on the controlled variable mediation level 540 described above, specifically, mediation of the injection function demand which is a feature of the present embodiment, will be described in detail with reference to FIG. 3 and FIGS. 4 to 6.

As described above, in the electronic control unit of the present embodiment, the demands concerning the fundamental functions of the engine 1 are expressed with a combination of three kinds of physical quantities and the demands expressed with the three kinds of the physical quantities are mediated on the physical quantity mediation level 520. The demand torques concerning the fundamental functions of the engine 1 are drivability, exhaust gas and fuel consumption. The three kinds of the physical quantities are toque, efficiency and air-fuel ratio. The fuel injection frequency and fuel injection amount are, just the controlled variables concerning the operations of the injectors 21, 22. If the controlled variables concerning the operations of the injectors 21, 22 are converted to physical quantities such as torque or efficiency, temporarily, mediated and then the controlled variables are calculated again, an excess calculation load occurs.

Therefore, in the present embodiment, the controlled variable mediation level 540 is provided just below the controlled variable setting level 530 as described above, so that the demand value of the controlled variables (injection controlled variable) concerning the operations of the injectors 21, 22 are transmitted to the controlled variable mediation level 540 not through the physical quantity mediation level 520. On the controlled variable mediation level 540, the demand values of the controlled variables (injection controlled variables) concerning the operations of the transmitted injectors 21, 22 are sorted to demand values during an operation of the engine 1 and demand values upon startup thereof and mediated. Further, the present embodiment is configured so that the demand values of the controlled variables (pump controlled variables) concerning operations of the fuel pumps 24, 25 are mediated on the controlled variable mediation level 540 in the same way as described above.

That is, as shown in FIG. 3, the demand generation level 510 includes a demand output portion 514 which outputs a demand for a fundamental injection function indispensable for driving the engine 1 appropriately. As well as the demand output portion 514, demand output portions 515 to 519 which output each function demand with a high priority depending on a necessity are provided. The function demands with a high priority include reduction in fuel pressure prior to fuel cut, quick warm-up of catalyst, stratified combustion startup, cancelation of start and stop (S&S) and injector protection.

The demands output from these demand output portions 514 to 519 are not physical quantities but demand values expressed with the controlled variables of the actuators 7, 8, [symbol] . As shown in FIG. 3, the demands output from the demand output portions 514 to 519 are transmitted directly to the controlled variable mediation level 540 not through the physical quantity mediation level 520 and the controlled variable setting level 530. With the demand values of the throttle opening amount, the ignition timing, and the air-fuel ratio transmitted from the controlled variable setting level 530 to the controlled variable mediation level 540 as described above, these transmitted demand values are aggregated about each controlled variable. The demand values aggregated about each controlled variable are mediated to a single demand value of each controlled variable by the respective mediation portions 541 to 543 of the controlled variable mediation level 540.

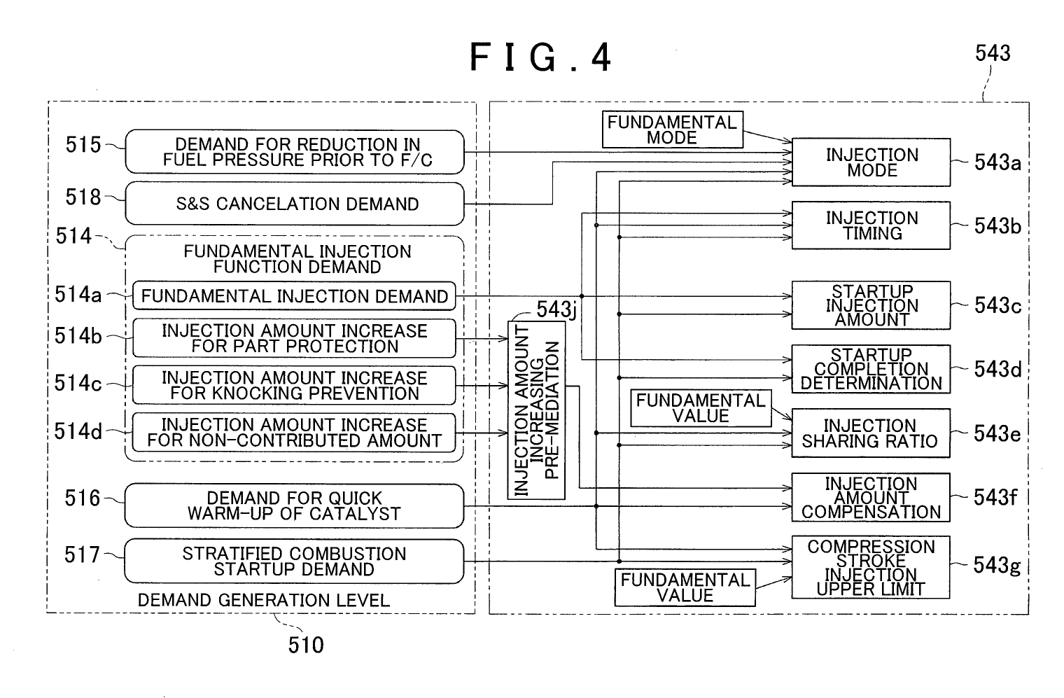

More specifically, signals output from the fundamental injection function demand output portion 514 on the demand generation level 510 are expressed with a plurality of injection controlled variables and transmitted to the injection function mediation portion 543 (543b to 543d described below with reference to FIG. 4) of the controlled variable mediation level 540. The fundamental injection function demands are fuel injection frequency (injection mode) of each of the two injectors 21, 22, injection timing of each of the injectors 21, 22, and an injection amount of each of the injectors 21, 22, which will be described with reference to FIG. 4 below.

The reason why the signal output from the fundamental injection function demand output portion 514 is expressed with a plurality of injection controlled variables is as follows. Fuel injected by the intake port injection injector 22 into the intake air port 11a of the engine 1 is mixed with air preliminarily and sucked into the cylinder 2. On the other hand, fuel mist injected directly into the cylinder 2 of the engine 1 by the cylinder injection injector 21 diffuses in the combustion chamber to form a fuel-air mixture with a high concentration. Thus, a frequency of fuel injections of the injectors 21, 22 and a ratio in fuel injection amount thereby affect a distribution of fuel-air mixture formed within the cylinder 2 of the engine 1 and combustibility thereof largely.

As an example, a demand value for performing multi-injection in a predetermined driving area on a high load side of the engine 1 is output from the fundamental injection demand output portion 514a (see FIG. 4). The multi-injection refers to fuel injection of executing fuel injection in a single combustion cycle dividedly by plural times with both the injectors of the cylinder injection injector 21 and the intake port injection injector 22 activated. The multi-injection is fuel injection which is to be performed to reduce fuel consumption by increasing the dispersibility of fuel mist when the engine 1 is in a predetermined driving area on the high load side. The demand value for multi-injection output from the fundamental injection demand output portion 514a is injection timing, for example.

In the present embodiment, the demand output portion 514 includes demand output portions 514b to 514d which output a demand (demand for increasing fuel) for increasing a fuel injection amount for part protection or knocking prevention. The reason is as follows. The demand for increasing fuel for part protection or knocking prevention is a demand which never changes injection mode or the like while increasing fuel. Quick warm-up of catalyst is a demand for changing injection mode. Because the demand for increasing fuel amount for part protection, or knocking prevention does not change injection mode, it affects combustibility of fuel-air mixture less than a demand for changing the injection mode such as quick warm-up of catalyst. Thus, the demand output portions 514b to 514d are included in the fundamental injection function demand output portion 514.

Like the aforementioned signal output from the demand output portion 514, a signal output from the demand output portion 515 for reduction in fuel pressure prior to fuel cut (F/C) is transmitted to the injection function mediation portion 543. If the fuel cut control of the engine 1 is performed, the temperature of fuel in the high-pressure fuel delivery pipe 20 rises during the fuel cut control operation, so that pressure of fuel (fuel pressure) in the high-pressure fuel delivery pipe 20 may increase. The reduction in fuel pressure prior to fuel cut mentioned here refers to a control for injecting a small amount of fuel by activating the cylinder injection injector 21 preliminarily just before startup of the fuel cut control in order to prevent the pressure of fuel (fuel pressure) in the high-pressure fuel delivery pipe 20 when the fuel cut control of the engine 1 is being performed. For the reason, a demand value signal for activating the cylinder injection injector 21 is output from the demand output portion 515 and the output signal is transmitted to the mediation portion 543 of the controlled variable mediation level 540.

On the other hand, signals output from the quick warm-up of the catalyst demand output portion 516 and the stratified combustion startup demand output portion 517 are transmitted to the throttle opening amount demand value mediation portion 541, the ignition timing demand value mediation portion 542, and the injection function mediation portion 543 of the controlled variable mediation level 540. The quick warm-up of the catalyst 17 refers to a special control for increasing the exhaust air temperature to a maximum extent in order to warm up the catalyst 17 in the shortest time after a cold start of the engine 1, for example.

More specifically, to raise the exhaust air temperature, the ignition timing is retarded up to after the top dead center (TDC) and the amount of air is increased by opening the throttle valve 8, so that the exhaust air heat amount is increased as much as possible. Further, the fuel injection timing in the compression stroke is retarded so that the concentration of fuel-air mixture around the ignition plug 6 is raised. Thus, signals about a demand value for increasing the throttle opening amount, a demand value for the ignition retardation, a demand value for the compression stroke injection, and a demand value for increasing fuel pressure are output from the demand output portion 516.

The stratified combustion startup refers to a control for starting the engine in the stratified combustion state in order to achieve both reduction of a startup time and a smooth startup of engine rotation. To achieve the stratified combustion startup, fuel is injected from the cylinder injection injector 21 in the compression stroke of the cylinder 2 of the engine 1 (fuel may be injected from the intake port injection injector 22 as well.) Therefore, demand values of a throttle opening amount, ignition timing, injection amount, injection timing and injection pressure (i.e., fuel pressure in the high-pressure fuel delivery pipe 20), which are suitable for the stratified combustion startup, are output from the demand output portion 517.

Further, a signal output from the S&S cancelation demand output portion 518 is also transmitted to the mediation portions 541 to 543. The S&S cancelation refers to an idling stop control for automatically stopping an operation of the engine 1 under a predetermined condition with a stop of a vehicle. A demand value for closing the throttle to suppress vibration when the engine 1 is stopped, a demand value for stopping ignition, and a demand value for stopping fuel injection and an operation of the low-pressure pump 24 are output from the demand output portion 518.

A signal output from the injector, protection demand output portion 519 is transmitted to only the mediation portion 543. In this example, specifically, the injector protection demand intends to reduce the pressure of fuel (fuel pressure) in the high-pressure fuel delivery pipe 20 to protect an O-ring provided on the cylinder injection injector 21. Thus, a demand value for reducing a target fuel pressure in the high-pressure pump 25 is output from the demand output portion 519.

In the present embodiment, an order of priority is set preliminarily about signals output from the demand output portions 514 to 519 transmitted to the controlled variable mediation level 540 not through the physical quantity mediation level 520 as described above. The demand values of the signals output from the demand output portions 514 to 519 are mediated according to the preliminarily set priority order. A specific priority order depends on a design of the electronic control unit and the order of priority is not limited to any specific one. As an example, the priority of the demands from demand output portions 515 to 519 is set higher than that of the fundamental injection function demand from the demand output portion 514.

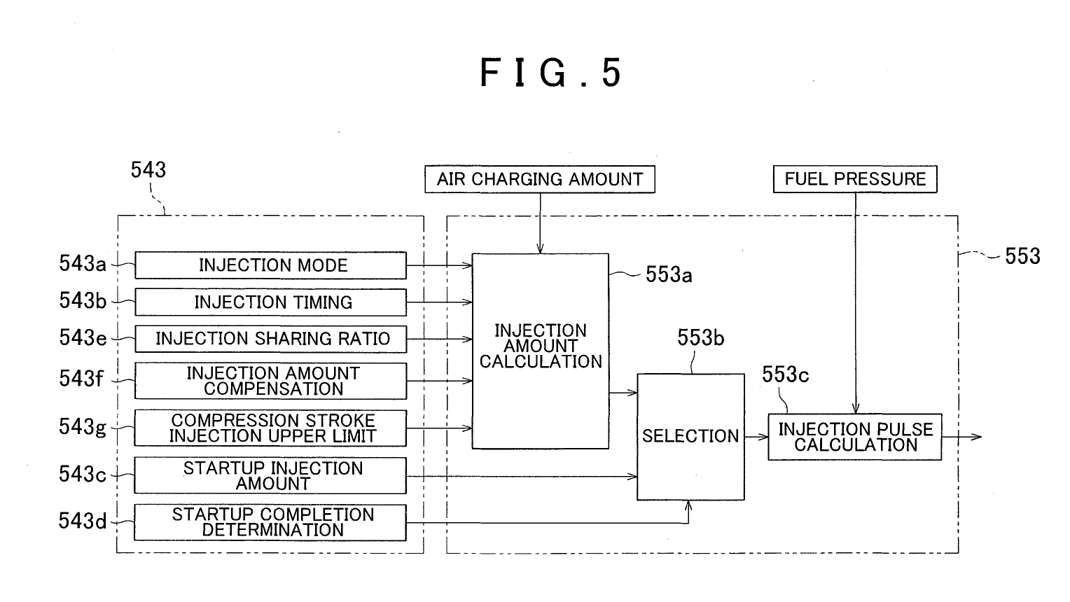

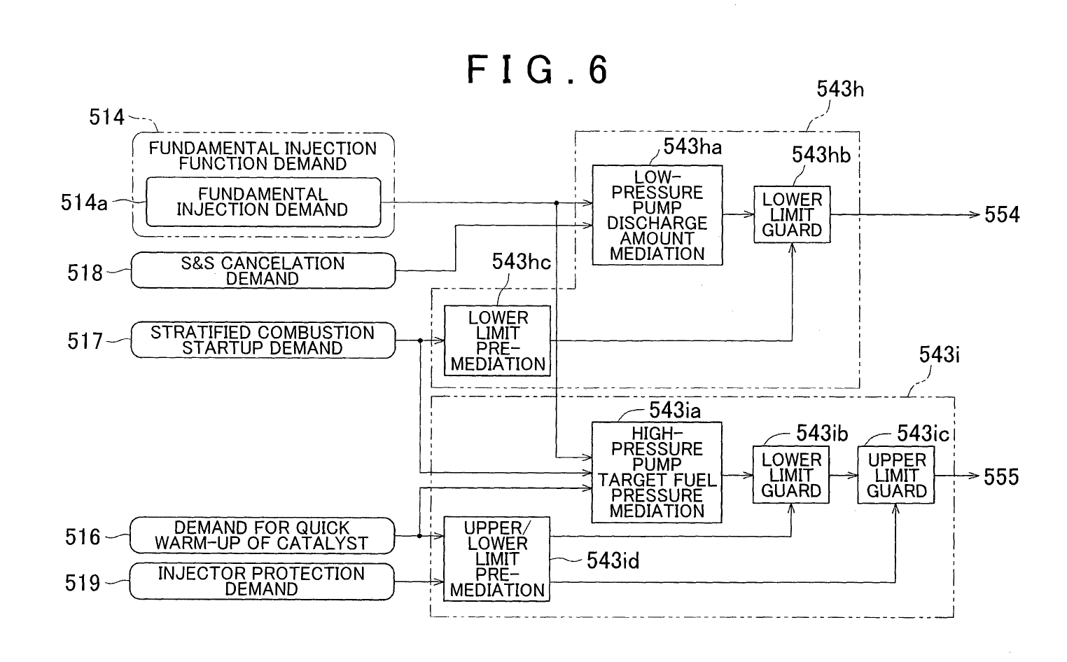

Hereinafter, mediation of injection controlled variable in the injection function mediation portion 543 will be described in detail with reference to FIG. 4 and FIG. 5. As described above, the injection function mediation portion 543 includes the first to seventh mediation portions 543a to 543g for mediating seven injection controlled variables indicating the operations of the injectors 21, 22, and the eighth, ninth mediation portions 543h, 543i (see FIGS. 3, 6) for mediating pump controlled variables indicating the operations of the fuel pumps 24, 25. The injection function mediation portion 543 mediates the controlled variable of the injection and the pump controlled variable collectively.

The first mediation portion 543a mediates injection mode as an injection controlled variable, that is, an injection frequency of fuel injection from each of the injectors 21, 22. More specifically, signals of injection modes corresponding to each of demands about reduction of fuel pressure, quick warm-up of catalyst, stratified combustion startup and S&S cancelation are transmitted to the first mediation portion 543a from each of the demand output portions 515 to 518 on the demand generation level 510.

As an example, if an injection mode of performing injection operations three times in a single combustion cycle by injecting fuel from the cylinder injection injector 21 in injection mode twice and then injecting fuel once from the port injection injector 22, a demand value of injection mode for performing the injection operation three times is transmitted. In case of injection mode for stopping the injection operations of the injectors 21, 22 for S&S cancelation, for example, a demand value of injection mode for stopping the injection operation is transmitted.

In the meantime, in the present embodiment, no signal of a demand value in injection mode is transmitted from the fundamental injection function demand output portion 514. As shown in FIG. 4, injection mode corresponding to a fundamental injection function demand is stored in the injection function mediation portion 543 preliminarily as a fundamental mode.

In the present embodiment, a signal output from the demand output portions 515 to 519 accompanies information which identifies each signal output and indicates an order of priority of their demands. The priority of the demands of signals output from the demand output portions 515 to 519 is higher than that of a demand in the fundamental mode. Therefore, if any signal is input to the mediation portion 543a, a demand value of one of the input signals is selected (mediated). For example, of the input signals, only a signal of a demand value with the highest priority may be selected. Of the input signals, any demand value signal may be selected and its demand value may be calculated by means of weighted average or the like so that demand values not selected are also reflected by weighting the selected demand value.

Like the first mediation portion 543a, the second mediation portion 543b mediates a fuel injection timing (injection startup timing) by the injectors 21, 22 as one of the controlled variables of the injection. A signal of a demand value indicating an injection startup timing of each of the injectors 21, 22 is transmitted from the demand output portions 514 (514a), 516, 517 on the demand generation level 510 to the second mediation portion 543b. Signals transmitted from the demand output portions 514 (514a), 516, 517 on the demand generation level 510 are transmitted as demand values of injection timing corresponding to each of demands about fundamental injection, quick warm-up of catalyst and stratified combustion startup.

For example, if the injection operations are performed three times by activating the cylinder injection injector 21 twice and the intake port injection injector 22 once as described before, a demand signal in which the injection operation of each time is expressed with a crank angle is transmitted. Then, mediation is performed according to a predetermined rule like the first mediation portion 543a. In the meantime, because the injection timing demand values are allocated to the injection operation of each time expressed with injection mode in order, the cylinder injection injector 21 and the intake port injection injector 22 are not distinguished.

As one of the controlled variables or the injection, the third mediation portion 543c mediates a fuel injection amount of each of the injectors 21, 22 upon startup of the engine 1. Signals of demand values which express a fuel injection amount of each time corresponding to injection demands for the fundamental injection and the stratified combustion startup are transmitted from the demand output portions 514 (514a), 517 on the demand generation level 510 to the third mediation portion 543c.

As an example, if the injection operations are performed twice by activating the cylinder injection injector. 21 once and the intake port injection injector 22 once for the stratified combustion startup, a signal of a demand value which expresses the injection amount of each time is transmitted. If the engine is started in a uniform combustion state at a cold place, for example, a demand value of a fuel injection amount of a single time by the intake port injection injector 22 is transmitted. Then, the mediation is performed according to the predetermined rule like the first, second mediation portions 543a, 543b.

The reason why the fuel injection amount upon startup is mediated separately from that during a driving of an engine is that upon startup of the engine 1, a charging amount of air into the cylinder 2 of the engine 1 cannot be calculated precisely. During a driving of the engine 1, a fuel injection amount is calculated from the air charging amount and target air-fuel ratio as described below. Because the air charging amount cannot be calculated precisely upon startup of the engine 1, the fuel injection amount must be set to a suitable value preliminarily. Thus, the fuel injection amount is set preliminarily to match with an operating state of the engine 1 upon startup, for example, stratified combustion startup or uniform combustion startup, an appropriate fuel injection amount is selected (mediate) from the preliminarily set fuel injection amounts.

As one of the controlled variables of the injection, the fourth mediation portion 543d mediates a standard value which determines completion of the aforementioned startup control. A determination value signal for determining completion of the startup in case of the uniform combustion, startup and the stratified combustion startup is transmitted from the demand output portions 514 (514a), 517 of the demand generation level 510 to the fourth mediation portion 543d. Then, the transmitted determination value is mediated according to the predetermined rule.

In case of uniform combustion startup by the fundamental injection, for example, when the engine speed upon startup exceeds a preliminarily set engine speed (determination engine speed), it is determined that the engine startup has completed. On the other hand, in case of stratified combustion startup, its generated torque is smaller than the uniform combustion startup. Thus, in case of the stratified combustion startup, the determination engine speed is selected (mediated) so that the startup of the engine has completed when the engine speed upon startup reaches a higher value than that upon the uniform combustion startup. Further, in case of a hybrid vehicle, because the engine might be started during a traveling with an electric motor, it may be determined that the startup has completed when the engine speed reaches a higher value.

In case of a hybrid vehicle, if the engine is started during a traveling with an electric motor, there is a possibility that the engine speed may reach a higher value than a determination engine speed upon normal startup when the startup control starts. In this case, if it is determined that the engine startup has been completed with a normal determination engine speed, at the same time when the startup control starts, a fuel injection amount after the startup is adopted. As a result, an excessive amount of fuel may be injected into a cylinder in which actually no fuel injection has been performed. Thus, in case of the hybrid vehicle, it may be determined that the startup has been completed after the engine speed reaches the aforementioned high value as described above.

As one of the controlled variables or the injection, the fifth mediation portion 543e mediates a ratio of fuel injection between the injectors 21 and 22 during a driving of the engine 1, that is, an injection sharing ratio. A signal of a demand value indicating a ratio of injection amount between the respective injectors 21 and 22 is transmitted to the fifth mediation portion 543e from the demand output portions 516, 517 of the demand generation level 510 as a demand value of injection sharing ratio corresponding to a demand for quick warm-up of catalyst and stratified combustion startup.

As an example, if the injection operations are performed three times by activating the cylinder injection injector 21 twice and the intake port injection injector 22 once, a demand value about an injection ratio between one time of the port injection and one time of the cylinder injection is transmitted in order of the injection operations (e.g., 40%, 40%) and the transmitted demand value is mediated according to the predetermined rule.

In the meantime, a remaining injection ratio (e.g., 20%) is allocated to the cylinder injection of the second time. Further, according to the present embodiment, no signal of the injection sharing ratio demand value is transmitted from the fundamental injection function demand output portion 514. The injection sharing ratio corresponding to the fundamental injection function demand is a fundamental value (i.e., 100%) corresponding to the port injection of one time based on the basic mode. As shown in FIG. 4, the fundamental value corresponding to the port injection of one time based on the basic mode is stored in the injection function mediation portion 543 preliminarily.

As one of the controlled variables of the injection, the sixth mediation portion 543f mediates a compensation coefficient of total injection amount of fuel. According to the present embodiment, the demand output portions 514b to 514d are contained in the fundamental injection function demand output portion 514. As well as the fundamental injection demands, the demand output portions 514b to 514d output a fuel increase compensation coefficient demand value for part protection, knocking prevention and compensation for non-contributed amount. An output demand value (signal) is transmitted to an injection amount increasing pre-mediation portion 543j and mediated (mediated preliminarily) according to a predetermined rule.

The injection amount compensation coefficient demand value output from the injection amount increasing pre-mediation portion 543j after such a pre-mediation is transmitted to the sixth mediation portion 543f. On the other hand, in the example of FIG. 4, the injection amount compensation coefficient demand value for quick warm-up of catalyst is transmitted from the demand output portion 516 to the sixth mediation portion 543f and the transmitted demand value is mediated according to a predetermined rule. The reason why the mediation is performed separately is that a preferable logic for each mediation is different.

That is, the demand (first kind of demand) for pre-mediation for part protection or knocking prevention is a demand which never changes the injection mode although total injection amount of fuel is changed. On the other hand, because a demand for quick warm-up of catalyst or the like (second kind of demand) changes the injection mode as well as the total injection amount of fuel, combustibility of fuel-air mixture in the cylinder 2 of the engine 1 is affected largely. Thus, the injection amount compensation coefficient is mediated according to a logic preferable for the first kind of demand in the injection amount increasing pre-mediation portion 543j as described above and then, the injection amount compensation coefficient is mediated according to a logic preferable for the second kind of demand in the sixth mediation portion 543f.

As one of the controlled variables or the injection, the seventh mediation portion 543g mediates an upper limit in injecting fuel in the compression stroke of the cylinder 2 from the cylinder injection injector 21, that is, a compression stroke injection upper limit. If the fuel injection amount in the compression step of the cylinder 2 of the engine 1 increase excessively, deflection in concentration of fuel-air mixture increases so that the concentration of fuel around an ignition plug, for example, intensifies thereby possibly worsening combustion state.

Then, as an example, a signal of an upper limit in fuel injection amount in the compression stroke by the cylinder injection injector 21 upon quick warm-up of catalyst control is transmitted from the demand output portion 516 to the seventh mediation portion 543g. Further, a signal of an upper limit of fuel injection amount in the compression stroke upon stratified combustion startup is transmitted from the demand output portion 517. The transmitted fuel injection amount upper limit is mediated according to the predetermined rule.

In the meantime, according to the present embodiment, no signal of the upper limit of fuel injection amount in the compression stroke is transmitted from the fundamental injection function demand output portion 514. The reason is that the injection mode corresponding to the fundamental injection function demand is basic mode in which no fuel is injected into the cylinder injection injector 21. As shown in FIG. 4, a fundamental value (maximum value) of fuel injection amount is stored preliminarily in the injection function mediation portion 543 for convenience.

As described above, the seven injection controlled variables hold simultaneity and in other words, the seven controlled variables are mediated collectively by correlating to each other. As a result, a preferable operation control for the injectors 21, 22 to various demands during a driving of the engine 1 and upon startup is achieved. In the meantime, the first, second and fifth to seventh mediation portions 543a, 543b, 543e-543g construct a fundamental injection control mediation portion which mediates injection controlled variable concerning operations of the injectors 21, 22 during a driving of the engine 1. The third, fourth mediation portions 543c, 543d construct a startup injection control mediation portion which mediates an injection control amount upon startup.

As shown in FIG. 5, signals from the first to seventh mediation portions 543a to 543g are transmitted to the control output portion 553 (injector driving control portion) of the control output level 550. This control output portion 553 has an injection amount calculation portion 553a which calculates a fuel injection amount of each of the injectors 21, 22. An injection mode demand value from the first mediation portion 543a of the injection function mediation portion 543 and an injection timing demand value from the second mediation portion 543b are transmitted to the control output portion 553, and the control output portion 553 calculates an injection amount of each injection operation specified according to an injection mode.

That is, demand values of each injection sharing ratio, injection amount compensation coefficient and compression stroke injection upper limit are transmitted to the injection amount calculation portion 553a from the fifth to seventh mediation portions 543e to 543g of the injection function mediation portion 543 and consequently, a fuel injection amount is calculated from a target air-fuel ratio, an air charging amount into the cylinder 2 and injection sharing ratio. For the target air-fuel ratio, its theoretical air-fuel ratio is set preliminarily as the fundamental value. The air charging amount into the cylinder 2 is contained in the common engine information. The injection amount calculation portion 553a compensates the fuel injection amount by multiplying the injection amount compensation coefficient and limits the injection amount in the injection operation in the compression stroke to the upper limit.

Then, the calculated fuel injection amount demand value and a fuel injection amount demand value upon startup from the third mediation portion 543c of the injection function mediation portion 543 are input to an injection amount selecting portion 553b of the control output portion 553, and of the input fuel injection amount demand values, any demand value is selected. That is, a startup completion determination value (e.g., engine speed) output from the fourth mediation portion 543d of the injection function mediation portion 543 is transmitted to the injection amount selecting portion 553b and if it is less than a real engine speed, the fuel injection amount upon startup is selected. On the other hand, when the real engine speed exceeds the startup completion determination value, the fuel injection amount calculated by the injection amount calculation portion 553a is selected as described above. The real engine speed is contained in the common engine information.

Based on the selected fuel injection amount demand value, a current fuel pressure and flow rate coefficients of the injectors 21, 22, a fuel injection period, that is, an injection pulse width of each of the injectors 21, 22 is calculated by an injection pulse calculation portion 553c. The calculated pulse width injection signal (injector driving signal) is output to the injectors 21, 22. The current fuel pressure is a fuel pressure of the high-pressure fuel delivery pipe 20 and the low-pressure fuel delivery pipe 23 contained in the common engine information.

Next, mediation of the pump control amount will be described with reference to FIG. 6. An eighth mediation portion 543h provided in the injection function mediation portion 543 as described above mediates a discharge amount of the low-pressure pump 24 as one of the pump controlled variables. Demand values (signals) of a discharge amount corresponding to the fundamental injection demand and a discharge amount (i.e., zero) corresponding to the S&S cancelation are transmitted to the eighth mediation portion 543h from the demand output portions 514(514a), 518 of the controlled variable mediation level 540.

That is, corresponding to the fundamental injection demand value from the demand output portion 514 (514a) during a driving of the engine 1, a demand value for driving the low-pressure pump 24 is transmitted to discharge fuel to match with the injection amount from the injectors 21, 22. On the other hand, in case of S&S cancelation, corresponding to stop of the operations of the injectors 21, 22, a demand value for zeroing the discharge amount of the low-pressure pump 24 (stopping the operation) is transmitted to the eighth mediation portion 543h.

As shown in FIG. 6, the mediation is performed according to the predetermined rule by a low-pressure pump discharge amount mediation portion 543ha in the eighth mediation portion 543h, so that a signal of a pump discharge amount demand value is transmitted to a lower limit guard portion 543hb. The lower limit guard portion 543hb compares a transmitted demand value with a lower limit guard value and if the transmitted demand value is over the lower limit guard value, the transmitted demand value is output and transmitted to a control output portion 554 for driving of the low-pressure pump 24. On the other hand, if the transmitted demand value is less than the lower limit guard value, the lower limit guard value is output and transmitted to the control output portion 554 for driving of the low-pressure pump 24.

For example, if a demand value for S&S cancelation (pump discharge amount is zero) is selected, the low-pressure pump 24 is stopped so that power consumption during a stop of the engine 1 can be reduced, which is advantageous for reduction of fuel consumption. However, even if the S&S cancelation demand value is selected in the low-pressure pump discharge amount mediation portion 543ha, it is sometimes desirable to start the low-pressure pump 24. In this case, the low-pressure pump 24 can be driven by setting the lower limit guard value appropriately.

More specifically, when achieving the stratified combustion startup of the stopped engine 1, the high-pressure pump 25 is activated to inject fuel in the compression stroke of the cylinder 2 of the engine 1. If bubbles exist in a fuel pipe at this time, no fuel is fed by first one or two rotation of the high-pressure pump 25 thereby reducing the startup responsibility of the engine 1. Thus, by activating only the low-pressure pump 24 for the stratified combustion startup to raise the pressure of fuel in the fuel pipe, the bubbles are extinguished.

For example, if the vehicle power is turned ON, a discharge amount lower limit value (not zero) signal of the low-pressure pump 24 is transmitted to a lower limit pre-mediation portion 543hc in the eighth mediation portion 543h from the stratified combustion startup demand output portion 517. A discharge amount lower limit value signal other than the aforementioned transmitted discharge amount lower limit value (not shown) is also transmitted to the lower limit pre-mediation portion 543hc. The transmitted discharge amount lower limit value is mediated by the lower limit pre-mediation portion according to the predetermined rule. Then, the discharge amount lower limit value (not zero) signal is transmitted to the lower limit guard portion 543hb and next transmitted to the control output portion 554. Therefore, even if the discharge amount demand value transmitted from the low-pressure pump discharge amount mediation portion 543ha is zero, the low-pressure pump 24 can be driven.

Likewise, the ninth mediation portion 543i mediates a target fuel pressure of the high-pressure pump 25 as one of the pump controlled variables. As shown in FIG. 6, signals of target fuel pressure demand values corresponding to the fundamental injection, quick warm-up of catalyst and stratified combustion startup are transmitted to the ninth mediation portion 543i from the demand output portions 514 (514a), 516, 517 of the controlled variable mediation level 540. For example, if the fundamental injection accompanies no fuel injection in the compression stroke of the cylinder 2 of the engine 1, it is not necessary to increase the pressure of fuel by activating the high-pressure pump 25.

On the other hand, if fuel is injected in the compression stroke of the cylinder 2 as in the stratified combustion startup, it is necessary to raise the pressure of fuel over a predetermined level by activating the high-pressure pump 25. Thus, if fuel is injected in the compression stroke of the cylinder 2 of the engine 1, a high target fuel pressure demand value is transmitted. Further, to achieve the stratified combustion state for quick warm-up of catalyst, a high target fuel pressure demand value is also transmitted. These demand values are mediated according to the predetermined rule by a high-pressure pump target fuel pressure mediation portion 543ia in the ninth mediation portion 543i.

A signal of the mediated high-pressure pump target fuel pressure demand value is transmitted from the high-pressure pump target fuel pressure mediation portion 543ia to the lower limit guard portion 543ib and the demand value transmitted to the lower limit guard portion 543ib is compared with the lower limit guard value. If the demand value transmitted to the lower limit guard portion 543ib is over the lower limit guard value, the transmitted demand value is transmitted to the upper limit guard portion 543ic. On the other hand, if the demand value transmitted to the lower limit guard portion 543ib is less than the lower limit guard value, the lower limit guard, value is transmitted to an upper limit guard portion 543ic. The demand value transmitted to the upper limit guard portion 543ic is compared with the upper limit guard value this time. Then, if the demand value transmitted to the upper limit guard portion 543ic is less than the upper limit guard value, the demand value transmitted to the upper limit guard portion 543ic is output and the demand value is transmitted to the control output portion 555 for driving the high-pressure pump 25. On the other hand, if the demand value transmitted to the upper limit guard portion 543ic is over the upper limit guard value, the upper limit guard value is output and the demand value is transmitted to the control output portion 555 for driving the high-pressure pump 25.

Usually, the target fuel pressure demand value from the high-pressure pump target fuel pressure mediation portion 543ia is located in a range between the upper limit value and the lower limit value, the discharge pressure of fuel from the high-pressure pump 25 is raised to obtain a fuel pressure necessary for the stratified combustion startup and the quick warm-up of catalyst. Further, even if the target fuel pressure demand value deviates from the range between the upper limit value and the lower limit value, the operation of the high-pressure pump 25 is limited so that the real target fuel pressure falls within the range between the upper limit value and the lower limit value. For example, when reducing the fuel injection pressure to protect the O-ring of the cylinder injection injector 21, a signal of the upper limit value of the target fuel pressure of the high-pressure pump 25 is transmitted from the demand output portion 519 to the ninth mediation portion 543i.

The transmitted upper limit value signal is transmitted to an upper/lower limit pre-mediation portion 543id in the ninth mediation portion 543i and the transmitted upper limit value is mediated according to the predetermined rule. If the mediated upper limit value is transmitted to the upper limit guard portion 543ic, even if the target fuel pressure demand value has been already transmitted from the high-pressure pump, target fuel pressure mediation portion 543ia as described above, an upper limit guard value lower than the transmitted target fuel pressure demand value is selected and transmitted to the control output portion 555.

Thus, in the high-pressure pump 25 which is activated receiving a driving signal from the control output portion 555, that target fuel pressure is limited to the aforementioned upper limit value or less, thereby protecting the O-ring and the like of the injector 21. Further, because a lower limit of the target fuel pressure demand value is set by the lower limit guard portion 543ib likewise, even if a demand value for stopping the high-pressure pump 25 is transmitted from the high-pressure pump target fuel pressure mediation portion 543i, the high-pressure pump 25 can be activated as required.

By correlating with the controlled variables (injection controlled variables) of the injectors 21, 22 as described above, the controlled variables (injection controlled variables) of fuel discharge amount and discharge pressure (target fuel pressure) from the fuel pumps 24, 25 are mediated in the eighth, ninth mediation portions 543h, 543i. As a result, while securing simultaneity of various demands concerning fuel injection function, the various demands concerning the fuel injection function are mediated to achieve combustion by forming an excellent fuel-air mixture. In addition, by performing pre-mediation about the upper limit value and the lower limit value of fuel discharge amount and discharge pressure, a demand for controlling the pump controlled variable independently of the controlled variable of the injection can be met.

As described above, in the electronic control unit of the present embodiment, a signal is transmitted in a single direction from the demand generation level 510 which is the highest level of the hierarchical structure, through the lower physical quantity mediation level 520, controlled variable setting level 530, and controlled variable mediation level 540 to the control output level 550, thereby reducing the control arithmetic operation load.

Further, the fundamental function demands of the engine 1 such as drivability, exhaust gas and fuel consumption are expressed with a combination of three kinds of physical quantities including torque, efficiency and air-fuel ratio and mediated on the physical quantity mediation level 520. As a result, the engine 1 can be driven in a preferable state in which those fundamental demands are satisfied at an excellent balance.

On the other hand, demands for fuel injection state such as multi-injection, stratified combustion startup, and quick warm-up of catalyst are transmitted directly to the controlled variable mediation level 540 not via the physical quantity mediation and mediated. In other words, various kinds of demands concerning the functions of the engine 1 are sorted to a suitable one of the physical quantity mediation and the controlled variable mediation and processed. As a result, all the function demands can be preferably achieved without increasing control arithmetic operation load excessively.

In the present embodiment, the injection function mediation portion 543 of the controlled variable mediation level 540 perform mediation integrally by correlating the controlled variables (injection controlled variables) of the injectors 21, 22 with the controlled variables (pump controlled variables) of the fuel pumps 24, 25. As a result, simultaneity of mediations of the controlled variable of the injection and the pump controlled variable concerning the fuel injection can be secured thereby achieving excellent combustion with an excellent fuel-air mixture.

Further, in the present embodiment, the injection function mediation portion 543 is provided with the third, fourth mediation portions 543c, 543d (startup injection control mediation portion) which mediate the controlled variables of the injection upon startup, separately from the first, second, fifth to seventh mediations 543a, 543b, 543e-543g (fundamental injection control mediation portion) which mediate the controlled variables of the injection during a driving of the engine 1. Thus, injection control demands which are different between during a driving and upon startup due to each different logic can be mediated preferably. In addition, the arithmetic operation load associated with the mediations both during a driving and upon startup can be reduced.

Although the embodiment of the present invention has been described above, the present invention is not restricted to the above-described embodiment, but may be modified within a range not departing from the spirit of the invention. For example, although the above-described embodiment has mentioned three kinds of functions including drivability, exhaust gas and fuel consumption as the fundamental function demand to the engine 1 and these function demands are expressed with three physical quantities such as torque, efficiency and air-fuel ratio and mediated, the present invention is not restricted to this example.

Further, the function demands which are expressed with the controlled variables of the actuators 7, 8, [symbol] instead of the three physical quantities and mediated are not restricted to reduction in fuel pressure prior to fuel cut (F/C), stratified combustion startup and quick warm-up of catalyst. As other function demands, various function demands for fail safe, OBD can be mentioned.

According to the above-described embodiment, the signals related to the operating condition and operating state of the engine 1 (common information) are distributed by the common signal distribution system. The signal related to the operating condition and operating state of the engine 1 (common information) may be distributed from a higher level to a lower level together with the demand value.

Further, in the above-described embodiment, the case where the electronic control unit of the present invention has been applied to the engine 1 including the cylinder injection injector 21 and the port injection injector 22, the present invention is no restricted to this example. The present invention can be applied to the electronic control unit of an engine including any one of the cylinder injection injector 21 and the intake port injection injector 22.

Further, the actuators of the engine 1 are not restricted to the igniter 7, the throttle valve 8, the injectors 21, 22 and the fuel pumps 24, 25 of the above-described embodiment. For example, a variable valve timing system (VVT), a variable valve lift system (VVL), and an exhaust gas recirculation system (EGR system) may be selected as an actuator to be controlled. In an engine with a cylinder stop system or a variable compression ratio system, those systems may be selected as an actuator to be controlled.

Further, although in the above embodiment, the case in which the electronic control unit of the present invention has been applied to the spark ignition type engine 1 mounted on a vehicle has been described, the present invention may be applied to other engines than the spark ignition type engine 1, for example, a diesel engine. Further, the present invention may be applied to a hybrid system with an electric motor.

What is claimed is:

1. An electronic control unit for an internal combustion engine, the electronic control unit being configured to achieve demands concerning various kinds of functions of the internal combustion engine by coordinative control of a plurality of actuators concerning an operation of the internal combustion engine, the electronic control unit comprising:
a demand generation level that generates and outputs demand values concerning the functions of the internal combustion engine;
a physical quantity mediation level that is provided just below the demand generation level, the physical quantity mediation level aggregating and mediating demand values expressed with a predetermined physical quantities of the demand values;
a controlled variable setting level that is provided just below the physical quantity mediation level, the controlled variable setting level setting controlled variables of the actuators based on the mediated demand values; and
a controlled variable mediation level that is provided just below the controlled variable setting level, the demand values expressed with the controlled variables of the actuators of the demand values output from the demand generation level being transmitted to the controlled variable mediation level not through the physical quantity mediation level, the controlled variable mediation level aggregating and mediating demand values expressed with controlled variables of the actuators set on the controlled variable setting level and the demand values expressed with the controlled variables of the actuators of the demand values that are transmitted to the controlled variable mediation level not through the physical quantity mediation level for each of the controlled variables;
wherein the electronic control unit includes a hierarchical control structure, and in the hierarchical control structure, the demand values output from the demand generation level are transmitted in a single direction from a higher level to a lower level in order of the demand generation level, the physical quantity mediation level and the controlled variable setting level, and
wherein the controlled variable mediation level includes a fundamental injection control mediation portion and a startup injection control mediation portion, the fundamental injection control mediation portion mediating controlled variables of injections concerning an operation of at least one of fuel injection valves which is one of the actuators during a driving of the internal combustion engine, and the startup injection control mediation portion mediating the controlled variables of the injections upon startup of the internal combustion engine,
wherein at least one of the fuel injection valve is disposed so as to inject fuel directly into a cylinder;
the electronic control unit distinguishes the demands expressed with the controlled variables of the injections between demands with a high priority and demands with a low priority;
the electronic control unit changes a total injection amount of fuel and does not change a frequency of injections of fuel in the demands with the low priority;
the electronic control unit changes both the total injection amount of the fuel and the frequency of injections of fuel in the demands with the high priority; and
after the controlled variables of the injections concerning the demands with the low priority are mediated, the fundamental injection control mediation portion mediates both the controlled variables of the injections concerning the mediated demands with the low priority and the controlled variables of the injections concerning the demands with the high priority.

2. The electronic control unit according to claim 1, wherein
the fundamental injection control mediation portion mediates an upper limit value of a fuel injection amount injected by the fuel injection valve that injects fuel directly into the cylinder, the fuel injection amount is a fuel injection amount injected when the cylinder is in a compression stroke, the fuel injection amount being one of controlled variables of the injections.

3. The electronic control unit according to claim 1, wherein
the fuel injection valve includes a first fuel injection valve and a second fuel injection valve;
the first fuel injection valve injects fuel directly into a cylinder of the internal combustion engine;
the second fuel injection valve injects fuel into an intake port provided on each cylinder of the internal combustion engine; and
the fundamental injection control mediation portion mediates a frequency of fuel injections to be performed by the first fuel injection valve and the second fuel injection valve and ratio in the fuel injection amount among respective injection times.

4. (canceled)

5. The electronic control unit according to claim 1, wherein the actuator contains at least one of fuel pumps for supplying fuel to the fuel injection valve;
the controlled variable mediation level has a pump control mediation portion; and the pump control mediation portion mediates a controlled variables of the pump concerning an operation of the fuel pump by correlating with the mediation of injection control which is to be performed in the fundamental injection control mediation portion or the startup injection control mediation portion.

6. The electronic control unit according to claim 5, wherein
when mediating the controlled variables of the injections to stop an operation of the fuel injection valve by the fundamental injection control mediation portion, the pump control mediation portion mediates a discharge amount of the pump which is the controlled variables of the pump to stop the operation of the fuel pump by correlating with the mediation of the controlled variable or the injection;
wherein the electronic control unit further includes a discharge amount limiting portion which sets a lower limit value of the mediated discharge amount of the pump.

7. The electronic control unit according to claim 5, wherein
the fuel pump is a high-pressure pump and the high-pressure pump supplies the fuel injection valve that injects fuel directly into the cylinder with high-pressure fuel with a higher pressure than a predetermined level;
wherein, when mediating the controlled variables of the injections to activate the fuel injection valve that injects fuel directly into the cylinder in a compression stroke of the cylinder of the internal combustion engine by the fundamental injection control mediation portion, the pump control mediation portion mediates a target pump fuel pressure of the high-pressure pump which is the controlled variable of the pump to raise fuel injection pressure by an operation of the high-pressure pump by correlating with the mediation of the injection controlled variable of the pump;
wherein the electronic control unit further includes a target fuel pressure limiting portion which sets at least one of the upper limit value and the lower limit value of the target pump fuel pressure of the high-pressure pump mediated by the pump control mediation portion.

8. A control method of an internal combustion engine, the control method for achieving demands concerning various kinds of functions of the internal combustion engine by coordinative control of a plurality of actuators concerning an operation of the internal combustion engine by an electronic control unit, wherein
the electronic control unit includes a hierarchical structure, and
in the hierarchical control structure, a demand values output from the demand generation level are transmitted in a single direction from a higher level to a lower level in order of the demand generation level, the physical quantity mediation level and the controlled variable setting level;
wherein the controlled variable setting level includes a fundamental, injection mediation portion and a startup injection controlled variable mediation portion, the control method comprising:
1) generating and outputting demand values concerning the functions of the internal combustion engine by the demand generation level;
2) aggregating and mediating demand values expressed with predetermined physical quantities of the demand values by the physical quantity mediating level;
3) setting controlled variables of the actuators based on the mediated demand values by the controlled variable setting level;
4) of the demand values output from the demand generation level, aggregating and mediating demand values expressed with the controlled variables of the actuators for each of the controlled variables by the controlled variable mediating level;
5) of the demand values output from a controlled variable mediation level, transmitting the demand values expressed with the controlled variable of the actuators to the controlled variable mediation level not through the physical quantity mediation level,
6) during a driving of the internal combustion engine, mediating the controlled variables of the injections concerning an operation of at least one of the fuel injection valves which is one of the actuators by a fundamental injection control mediation portion contained in the controlled variable mediation level, and
7) mediating the controlled variables of the injections upon startup of the internal combustion engine by the startup injection control mediation portion contained in the controlled variable mediation level,
wherein at least one of the fuel injection valve is disposed so as to inject fuel directly into a cylinder;
the electronic control unit distinguishes the demands expressed with the controlled variables of the injections between demands with a high priority and demands with a low priority;
the electronic control unit changes a total injection amount of fuel and does not change a frequency of injections of fuel in the demands with the low priority;
the electronic control unit changes both the total injection amount of the fuel and the frequency of injections of fuel in the demands with the high priority; and
after the controlled variables of the injections concerning the demands with the low priority are mediated, the fundamental injection control mediation portion mediates both the controlled variables of the injections concerning the mediated demands with the low priority and the controlled variables of the injections concerning the demands with the high priority.
